(19) United States
(12) Patent Application Publication
(10) Pub. No.: US 2008/0121128 A1
(43) Pub. Date: May 29, 2008

(54) CUSHIONING SHEET, PRINTING APPARATUS AND PRINTING METHOD

(75) Inventors: Tsuneyuki AMANO, Ibaraki-shi (JP); Takashi IMOTO, Ibaraki-shi (JP); Rie NAKAHIRA, Ibaraki-shi (JP); Noritaka OSUKA, Ibaraki-shi (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 11/946,163

(22) Filed: Nov. 28, 2007

(30) Foreign Application Priority Data
Nov. 29, 2006 (JP) 2006-321925

(51) Int. Cl. B41F 13/08

(52) U.S. Cl. 101/375; 101/483

(57) ABSTRACT

A printing apparatus includes a plate cylinder having a relief plate mounted on at least a part of an outer periphery of the plate cylinder and being operable to be rotationally driven about a shaft center, and an impression cylinder having a rigid outer periphery and being operable to be rotationally driven about a shaft center parallel to the shaft center of the plate cylinder. The impression cylinder is adapted to be brought into pressure contact with the relief plate via a sheet-like print object fed between the plate cylinder and the impression cylinder. A cushioning sheet is attachable to and detachable from the outer periphery of the impression cylinder. The cushioning sheet is elastically deformable when being brought into pressure contact with the relief plate on the plate cylinder via the print object. The cushioning sheet is restorable when being separated from the relief plate on the plate cylinder.

The disclosure of Japanese Patent Application No. 2006-321925 filed Nov. 19, 2006 including specification, drawings and claims is incorporated herein by reference in its entirety.

### BACKGROUND

This invention relates to a cushioning sheet for a printing apparatus that performs printing by feeding a sheet-like print object between a plate cylinder and an impression cylinder, the printing apparatus, and a printing method.

Various related-art printing apparatuses have heretofore been provided for printing on a sheet-like print object. As shown in FIG. 5, one of the related-art printing apparatuses has a relief plate 50′ mounted on at least a part of an outer periphery, a plate cylinder 10′ rotationally driven about a shaft center, and an impression cylinder 20′ rotationally driving about a shaft center that is substantially parallel to the shaft center of the plate cylinder 10′.

In such printing apparatus, a sheet-like print object S′ is fed between the plate cylinder 10′ and the impression cylinder 20′, which are rotationally driven, and the impression cylinder 20′ is configured to be brought into pressure-contact with the relief plate 50′ that is on the plate cylinder 10′ via the print object S′. With such configuration, an ink applied on the relief plate 50′ on the plate cylinder 10′ is transferred onto a print surface of the print object S′.

The printing apparatus uses a metal roll of which an outer periphery is formed of a metal as the impression cylinder 20′ when printing linear images such as a line and a character and uses a rubber roll of which an outer periphery is formed of a rubber as the impression cylinder 20′ when printing solid images or halftone dots by densely fixing the ink on a predetermined region. More specifically, since a contact area between the relief plate 50′ (pattern of the relief plate 50′) and the print object S′ is remarkably large when printing solid images or halftone dots by densely fixing the ink on the predetermined region relative to a contact area when printing linear images, when the metal roll having the rigid surface is used as the impression cylinder 20′ and brought into pressure-contact with the plate cylinder 10′, a pressure is not applied uniformly on a whole part of the region on which the ink is to be fixed to cause a part on which the ink is not transferred on the print object S′ in some cases. Accordingly, in the printing apparatus of the above configuration, the rubber roll of which the outer periphery is deformed along the plate cylinder 10′ (relief plate 50′) for uniformly applying the pressure-contact force of the impression cylinder 20 to the plate cylinder 10′ (relief plate 50′) is used as the impression cylinder 20′ when printing the solid images and the like.

The printing apparatus of the above configuration is capable of performing appropriate printing in accordance with a print mode (pattern of the relief plate) by changing the impression cylinder 20′.

However, since the printing apparatus of the above configuration requires the replacement of the impression cylinder 20′ depending on the printing pattern as described above, the printing apparatus has problems of complicated replacement work and a reduction in printing efficiency. That is, the work is complicated since it is necessary to perform centering of the impression cylinder 20′ as well as to adjust the pressure-contact force of the impression cylinder 20′ with respect to the plate cylinder 10′ every time the impression cylinder 20′ is replaced, and the printing efficiency is reduced due to an increase in halt period for printing.

Also, since a surface of the rubber roll 20′ of the printing apparatus of the above configuration tends to be worn by the contact with the print object S′ when printing solid images and the like, there is a problem that it is necessary to frequently replace the rubber roll 20′ with a new rubber roll 20′ in order to maintain the pressure applied to the plate cylinder 10′ (relief plate 50′) to an appropriate state.

Particularly, in the printing apparatus of intermittent rotary type, after a pattern of the relief plate 50′ is printed by mounting the relief plate 50′ on a part of the plate cylinder 10′ and feeding the print object S′ in one direction in accordance with a rotation speed of the plate cylinder 10′ and the impression cylinder 20′ and before the relief plate 50′ of the plate cylinder 10′ and the impression cylinder 20′ are brought into contact with each other again (when the plate cylinder 10′ and the impression cylinder 20′ are in a non-pressure-contact state), a gap between printing regions (print patterns) on the print object S′ is narrowed by feeding the print object S′ by a certain amount after changing the feeding direction of the print object S′ to the other direction (reverse feeding) and then changing the feeding direction of the print object S′ to the original direction again in a state where the relief plate 50′ and the impression cylinder 20′ are brought into contact with each other. Therefore, since the print object S′ is fed in a state where the print object S′ is in contact with the surface of the rotationally driven rubber roll 20′, there are problems that the life of the impression cylinder 20′ is prominently short due to rapid wear of the rubber roll 20′, and that a frequency of performing the complicated work of replacing the impression cylinder 20′ is increased.

In order to overcome the complication of the replacement work for the impression cylinder 20′, a use of either one of the rubber roll or the metal roll (single roll) as the impression cylinder 20′ may be considered based on the premise of adjusting the pressure-contact force of the impression cylinder 20′ to the plate cylinder 10′. However, with the use of the rubber roll as the impression cylinder 20′, there is a problem that it is difficult to perform appropriate printing due to deformation of the outer periphery of the impression cylinder 20′ in the case of printing linear images.

On the other hand, when the impression cylinder 20′ is formed of the metal roll, there is a problem that life of the relief plate 50′ becomes shorter due to a crack and the like that are generated on the relief plate 50′ in a short time by printing solid images and the like. More specifically, since it is necessary to apply the pressure-contact force on a wide area in the case of printing solid images and the like, the pressure-contact force for printing linear images results in a reduction in pressure per unit area, and, therefore, it is necessary to apply a pressure-contact force that is higher than that for the case of printing linear images. The increase in pressure-contact force results in a high impact to the relief plate 50′ when the rigid outer periphery of the metal roll is brought into pressure-contact with the relief plate 50′ (when the plate cylinder 10′ and the impression cylinder 20′ rotate to be brought into pressure-contact repeatedly), thereby causing a problem that the relief plate 50′ is shortly damaged. Particularly, since the damage on the relief plate 50′ is greater due to the intermittent repetitive pressure-contact between the relief plate 50′ and the impression cylinder 20′ in the above-described intermittent rotary printing apparatus, the life of the relief plate 50′ becomes prominently short.

### SUMMARY

It is therefore an object of the invention to provide a cushioning sheet for a printing apparatus, a printing apparatus, and a printing method enabling appropriate printing in accordance with a print mode without replacing an impression cylinder while preventing a reduction in life of a relief plate mounted on a plate cylinder.

In order to achieve the above described object, according to an aspect of the invention, there is provided a cushioning sheet for a printing apparatus which includes a plate cylinder having a relief plate mounted on at least a part of an outer periphery of the plate cylinder and being operable to be rotationally driven about a shaft center, and an impression cylinder having a rigid outer periphery and being operable to be rotationally driven about a shaft center parallel to the shaft center of the plate cylinder, the printing apparatus in which the impression cylinder is adapted to be brought into pressure contact with the relief plate via a sheet-like print object fed between the plate cylinder and the impression cylinder, wherein the cushioning sheet is attachable to and detachable from the outer periphery of the impression cylinder; wherein the cushioning sheet is elastically deformable when being brought into pressure contact with the relief plate on the plate cylinder via the print object; and wherein the cushioning sheet is restorable when being separated from the relief plate on the plate cylinder.

Since the cushioning sheet is attachable to the outer periphery of the impression cylinder and capable of elastic deformation in a state of being in pressure-contact with the relief plate on the plate cylinder via the print object, when the cushioning sheet is attached to the outer periphery of the impression cylinder, the cushioning sheet is elastically deformed by the pressure-contact with the relief plate (plate cylinder) in the case of printing solid images and the like (in the case where a pressure-contact force applied to the plate cylinder is high) to absorb an impact caused by the pressure-contact as well as to cause a uniform pressure to be applied to the relief plate by way of a restoring force due to the elastic deformation. Therefore, it is possible to perform high quality printing while preventing the relief plate from being damaged.

Also, since the cushioning sheet is restored in a state of being separated from the relief plate on the cylinder plate (in a state where the pressure-contact is released), when the cushioning sheet is attached to the plate cylinder in a mode where the relief plate is intermittently brought into pressure-contact with the impression cylinder, the relief plate is brought into pressure-contact with the cushioning sheet that has restored from the elastic deformation. Accordingly, when the cushioning sheet is brought into pressure-contact with the relief plate via the print object, the cushioning sheet is elastically deformed again and absorbs an impact caused by the pressure-contact and causes a uniform pressure to be applied to the relief plate by way of the restoring force as described above. Therefore, when printing is performed by intermittently bringing the relief plate and the impression cylinder (cushioning sheet) to pressure-contact with each other, it is possible to perform high quality printing while preventing the relief plate from being damaged.

Further, since the cushioning sheet is detachable from the impression cylinder, it is possible to realize a state appropriate for printing linear images by detaching the cushioning sheet from the impression cylinder for bringing the rigid outer periphery of the impression cylinder and the relief plate into pressure-contact with each other via the print object.

Therefore, by attaching and detaching the cushioning sheet to and from the outer periphery of the impression cylinder, it is possible to switch between the state appropriate for printing linear images and the state appropriate for printing solid images and halftone dots without replacing the impression cylinder. Also, in the case where the cushioning sheet is worn due to printing, it is possible to readily replace the cushioning sheet with a new cushioning sheet without replacing the impression cylinder.

The cushioning sheet may comprise: a cushioning layer being directly or indirectly attachable to and detachable from the outer periphery of the impression cylinder; and a surface layer directly or indirectly laminated on the cushioning layer and operable to be brought into pressure contact with the relief plate on the plate cylinder via the print object, wherein the cushioning layer may be comprised of an resin material having a first elasticity; and wherein the surface layer may be comprised of a deformable resin film having a second elasticity which is lower than the first elasticity.

With such configuration, by attaching the cushioning sheet to the outer periphery of the impression cylinder in the case of printing solid images and the like (in the case where the pressure-contact force applied to the plate cylinder is high), the surface layer is deformed due to the pressure-contact with the relief plate (plate cylinder), and the cushioning layer is elastically deformed along with the deformation of the surface layer. Accordingly, an impact due to the pressure-contact is absorbed, and it is possible to apply a uniform pressure to the relief plate by way of a restoring force due to the elastic deformation. Therefore, it is possible to perform high quality printing while preventing the relief plate from being damaged. Since the surface layer is made from the resin film less elastic than the cushioning layer, a pattern of the relief plate is hardly or never remain as a trace when the surface layer is brought into pressure-contact with the relief plate, thereby making it possible to maintain the function of uniformly applying the restoring force of the cushioning layer to the relief plate via the print object for a long time. Also, due to the less elastic surface layer, the cushioning sheet is hardly worn and suppressed from depletion.

The cushioning layer may be comprised of an urethane-based resin; and the surface layer may be comprised of a polyethylenetelephthalate film. When the cushioning layer is comprised of the urethane-based resin, the cushioning layer is capable of elastic deformation and has a high restoring force. When the surface layer is made from the PET resin, the surface layer is deformable and less elastic (more rigid) than the cushioning layer.

The cushioning layer may have adhesion. With such configuration, it is possible to attach the cushioning layer (cushioning sheet) directly to the impression cylinder without separately providing a pressure sensitive adhesive layer or a viscous layer. In addition, it is possible to smoothly detach the cushioning sheet from the impression cylinder.

According to another aspect of the invention, there is also provided a printing apparatus, comprising: a plate cylinder having a relief plate mounted on at least a part of an outer periphery of the plate cylinder and being operable to be rotationally driven about a shaft center; an impression cylinder having a rigid outer periphery and being operable to be rotationally driven about a shaft center parallel to the shaft center of the plate cylinder; and a cushioning sheet detachably attached to the outer periphery of the impression cylinder so as to correspond to the relief plate on the plate cylinder, wherein the impression cylinder is adapted to be brought into pressure contact with the relief plate via a sheet-like print object fed between the plate cylinder and the impression cylinder; wherein the cushioning sheet is elastically deformable when being brought into pressure contact with the relief plate on the plate cylinder via the print object; and wherein the cushioning sheet is restorable when being separated from the relief plate on the plate cylinder. Since the printing apparatus is provided with the cushioning sheet, it is possible to achieve the same functions and effects as those of the above described cushioning sheet.

According to a further aspect of the invention, there is also provided a printing method, comprising: attaching the above described cushioning sheet to the outer periphery of the impression cylinder so as to correspond to the relief plate on the plate cylinder; driving the plate cylinder and the impression cylinder in synchronization with each other; feeding the print object between the plate cylinder and the impression cylinder; and printing on the print object. According to the printing method, since printing is performed with the above described cushioning sheet being attached to the impression cylinder, it is possible to achieve the same functions and effects as those of the above described cushioning sheet.

According to the cushioning sheet, the printing apparatus, and the printing method of the aspects of the invention, it is possible to achieve the excellent effect of performing printing appropriate for a printing mode without replacing the impression cylinder while preventing a life the relief plate mounted on the plate cylinder from being shortened.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a diagram schematically showing a printing apparatus according to an embodiment of the invention;

FIG. 2 is an enlarged view showing a part of a cushioning sheet to be attached to an impression cylinder of the printing apparatus according to the embodiment;

FIGS. 3(a) to 3(e) are diagrams showing an operation of printing solid images and the like in the printing apparatus according to the embodiment, wherein FIG. 3(a) shows a state of feeding a print object between a plate cylinder and the impression cylinder, FIG. 3(b) shows a state in which the print object is sandwiched between the plate cylinder (relief plate) and the impression cylinder (cushioning sheet) so that printing is performed on the print object, FIG. 3(c) shows a state in which the print object on which the pattern of the relief plate is printed is fed to the downstream, FIG. 3(d) shows a state in which the print object on which the pattern of the relief plate is printed is fed after the feeding direction of the print object has been changed, and FIG. 3(e) shows a state in which the feeding direction of the print object is changed again toward the downstream to perform next printing;

FIGS. 4(a) to 4(e) are diagrams showing an operation of printing linear images in the printing apparatus according to the embodiment, wherein FIG. 4(a) shows a state of feeding a print object between a plate cylinder and the impression cylinder, FIG. 4(b) shows a state in which the print object is sandwiched between the plate cylinder (relief plate) and the impression cylinder (cushioning sheet) so that printing is performed on the print object, FIG. 4(c) shows a state in which the print object on which the pattern of the relief plate is printed is fed to the downstream, FIG. 4(d) shows a state in which the print object on which the pattern of the relief plate is printed is fed after the feeding direction of the print object has been changed, and FIG. 4(e) shows a state in which the feeding direction of the print object is changed again toward the downstream to perform next printing; and

FIG. 5 is a diagram schematically showing a related-art printing apparatus.

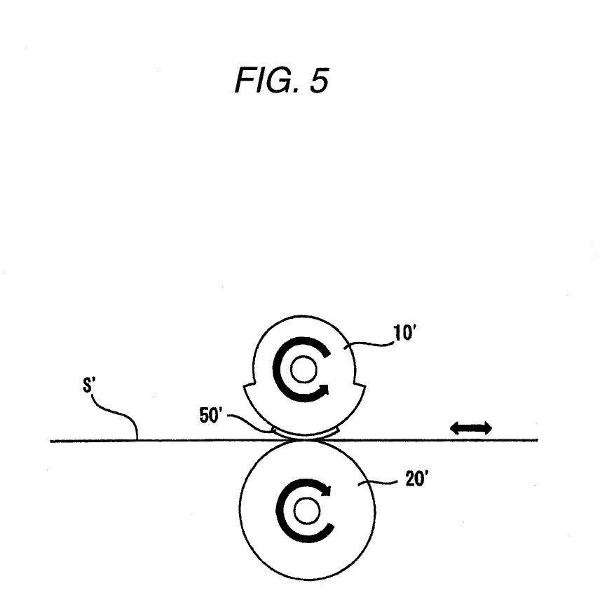

### DETAILED DESCRIPTION OF THE EMBODIMENTS

Hereinafter, an embodiment of this invention will be descried with reference to the accompanying drawings. In this embodiment, since a cushioning sheet for a printing apparatus (hereinafter simply referred to as cushioning sheet) is used as one of component parts of the printing apparatus, the entire constitution of the whole printing apparatus and the entire printing method will be included in the description.

The printing apparatus according to this embodiment is provided with a plate cylinder 10 having a relief plate (resin relief plate in this embodiment) 50 mounted on at least a part of an outer periphery of the plate cylinder 10 and rotationally driven about a shaft center, an impression cylinder 20 rotationally driven about a shaft center substantially parallel to the shaft center of the plate cylinder 10, an ink roller 30 for applying an ink to the relief plate 50 mounted on the plate cylinder 10, and a feeding device (not shown) for feeding a print object S between the plate cylinder 10 and the impression cylinder 20. Various objects may be used as the print object S, and the print object in this embodiment means a sheet-like object obtained by laminating a sealing material (not shown) having a pressure sensitive adhesive layer formed on one side of a strip-shaped substrate and a strip-shaped exfoliate paper (not shown) detachably attached to the pressure sensitive adhesive layer of the sealing material.

The plate cylinder 10 according to this embodiment is provided with a plate mounting member 10a having an outer periphery set to a predetermined curvature radius and a small diameter member 10b having a curvature radius of an outer periphery set to a smaller diameter than that of the plate mounting member 10a, and the relief plate 50 is to be mounted on the outer periphery of the plate mounting member 10a. The plate mounting member 10a and the small diameter member 10b are formed continuously in a circumferential direction so that curvature centers thereof are coaxial. In the plate cylinder 10, the plate mounting member 10a and the small diameter member 10b that are different in curvature radius extend in a direction of the shaft center of the plate cylinder 10 and formed at predetermined angles around the shaft center.

In the plate cylinder 10, the relief plate 50 is detachably mounted on the outer periphery of the plate mounting member 10a. Mounting (adhesion) of the relief plate 50 on the plate mounting member 10a is performed by way of a weakly viscous pressure sensitive adhesive agent, a two-sided adhesive tape, or the like. With such constitution, it is possible to readily replace the relief plate 50 without using any tools.

The impression cylinder 20 has a column-like appearance, unlike the plate cylinder 10, and at least an outer periphery thereof is rigid. An impression cylinder made from a metal (so-called metal roll) is used as the impression cylinder 20 according to this embodiment. The impression cylinder 20 is so disposed as to be brought into pressure-contact with the plate cylinder 10 (relief plate 50 on the plate mounting member 10a) and rotationally driven in synchronization with the plate cylinder 10. Further, the impression cylinder 20 is biased toward the plate cylinder 10 so that the impression cylinder 20 is directly or indirectly brought into pressure-contact with the plate cylinder 10 (relief plate 50). A pressure-contact force of the impression cylinder 20 according to this embodiment to the plate cylinder 10 is adjusted depending on the type of the relief plate 50 (linear image, solid image, dot) by adjusting a biasing force toward the plate cylinder 10.

The ink roller 30 has a substantially column-like appearance and is so disposed that an outer periphery thereof is brought into contact with the relief plate 50 on the rotationally driven plate cylinder 10 and rotationally driven about a shaft center in synchronization with the plate cylinder 10. An ink is applied on the outer periphery of the ink roller 30 by an ink supply unit (not shown), and the ink applied to the ink roller 30 is transferred (applied) to the relief plate 50 on the plate cylinder 10 rotating in synchronization.

The feeding device is formed of a plurality of pairs of rollers disposed with a gap being defined between adjacent rollers, for example, and the print object S is fed by the roller pairs as being in pressure-contact with the roller pairs. The feeding device according to this embodiment feeds the print object S at a feeding speed corresponding to a rotation speed of the plate cylinder 10 and the impression cylinder 20, so that the print object S is fed between the plate cylinder 10 and the impression cylinder 20. With such constitution, printing on the print object S is performed in a state where the print object S is sandwiched between the plate cylinder (relief plate 50) and the impression cylinder 20 as being fed by the feeding device.

In this embodiment, since the relief plate 50 is mounted on a part of the outer periphery of the plate cylinder 10 (on the plate mounting member 10a), when a long print object S is fed continuously in one direction in which the print object S is fed between the plate cylinder 10 and the impression cylinder 20, a wasteful region on which no printing is performed is increased in the print object S. Therefore, the feeding device according to this invention feeds the print object S on which printing by the relief plate 50 is performed for a predetermined amount in one direction and then in the other direction (reverse direction) and switches the feeding direction again to the original direction when or before the relief plate 50 on the plate cylinder 10 contacts again the print object S (when or before a next printing is started). With such constitution, it is possible to perform a plurality of printings in a state where a gap between patterns of the relief plate 50 is narrowed in the case where the relief plate 50 contacts the print object S intermittently by continuous rotational driving of the plate cylinder 10 and the impression cylinder 20 in a certain direction.

That is, the printing apparatus according to this embodiment employs an intermittent rotary mode with which the feeding direction of the print object S by the feeding device is switched depending on a printing timing by the plate cylinder 10 and the impression cylinder 20, so that a pattern image formed on the relief plate 50 is printed on the continuous strip-shaped print object S continuously and at a predetermined interval.

The printing apparatus according to this invention is provided with a cushioning sheet 40 that is attachable to and detachable from the outer periphery of the impression cylinder 20. The cushioning sheet 40 is attached to the cylinder plate 20 corresponding to the position of the relief plate 50 mounted on the plate cylinder 10 appropriately depending on a printing mode for the print object S. That is, the cushioning sheet 40 is attached to the outer periphery of the impression cylinder 20 in the case where the ink is densely deposited on a predetermined region for printing solid images and halftone dots (in the case where the relief plate 50 on which a pattern of solid images, halftone dots, or the like are formed is mounted on the plate cylinder 10). The cushioning sheet 40 is elastically deformed in a state where the cushioning sheet 40 is brought into pressure-contact with the relief plate 50 on the plate cylinder 10 via the print object S and restored in a state where the relief plate 50 of the plate cylinder 10 is separated from the cushioning sheet 40.

The cushioning sheet 40 is detached from the impression cylinder 20 in order to bring the relief plate 50 on the plate cylinder 10 into pressure-contact with the rigid outer periphery of the impression cylinder 20 via the print object S in the case of printing thin lines (linear images) such as characters (in the case of mounting a relief plate 50 on which linear images are formed on the plate cylinder 10).

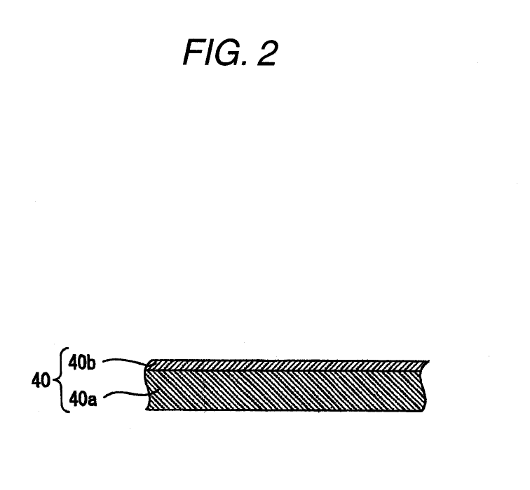

More specifically, the cushioning sheet 40 according to this embodiment is provided with a cushioning layer 40a directly and detachably attached to the impression cylinder 20 and a surface layer 40b laminated directly on the cushioning layer 40 and brought into contact with the relief plate 50 on the plate cylinder 10 via the print object S as shown in FIG. 2.

The cushioning layer 40a according to this embodiment is made from an elastic resin material, and a weakly viscous urethane-based resin is used in this embodiment. With such cushioning layer 40a, the cushioning sheet 40 according to this embodiment is attachable to and detachable from the outer periphery of the impression cylinder 20. That is, in the cushioning layer 40a according to this embodiment, the urethane-based resin material is used for enabling the cushioning layer 40a to function as a viscosity agent (pressure sensitive adhesive agent) to be attached to the impression cylinder 20 in addition to the original function.

In the cushioning layer 40a according to this invention, a thickness is set to 80 to 1,000 μm, preferably 100 to 300 μm (280 μm in this embodiment), and a storage elastic modulus is set to 2.00×104 to 2.00×105 (Pa). Further, in order to enable the cushioning layer 40a to function as the viscosity agent detachable from the impression cylinder 20 in this embodiment as described above, an adhesion property is set to 2N/20 mm or less, preferably 1.8 N/20 mm or less.

For the cushioning layer 40a (urethane-based viscosity agent), it is preferable to use a polyether-polyurethane-based material obtained by using propyleneglycol as polyol and by using an isocyanate compound having aliphatic urethane or alicyclic urethane as diisocyanate. Examples of aliphatic urethane include HDI (hexamethylenediisocyanate), XDI (xylilenediisocyanate), hydrogenated MDI [4,4′-methylenebis(cycloohexylisocyanate)], and the like, and examples of alicyclic urethane include IPDI (isophorone diisocyanate), H6XDI [1,3-bis(isocyanatomethyl)cyclohexane], and the like.

The surface layer 40b is deformable and formed of the resin film that is less elastic than the cushioning layer. On the premise that the surface layer 40b is deformable and less elastic than the cushioning layer 40a, a thickness and a storage elastic modulus thereof are set. The thickness of the surface layer 40b is not particularly limited insofar as the thickness satisfies flexibility and may preferably be set to 50 to 125 μm. In this embodiment the thickness is set to 75 μm, and the storage elastic modulus is set to 9.00×10⁷ to 4.00×10⁹ (Pa), preferably 1.00×10⁸ to 5.00×10⁸ (Pa).

In order to satisfy the above conditions, a drawn or non-drawn film of a polyester film such as polyethylene telephthalate, polybutylene telephthalate, and polyethylene naphthalate; a polyolefin film such as polyethylene and polypropylene; a cellulose-based resin film such as cellulose diacetate and cellulose triacetate; a polycarbonate film; and the like may be used for the surface layer 40b. It is preferable to use a biaxially drawn polyester film that is excellent particularly in heat resistance, mechanical strength, and dimension stability, and, particularly, a polyethylene telephthalate (PET) film is most suitable from the view points of heat resistance and economy. An adhesion improving treatment such as a Colona treatment may be performed on a viscosity agent coating surface of the surface layer 40b as required for improving an anchor effect.

Hereinafter, a method for printing on the print object S by using the printing apparatus of the above configuration (printing method) will be described.

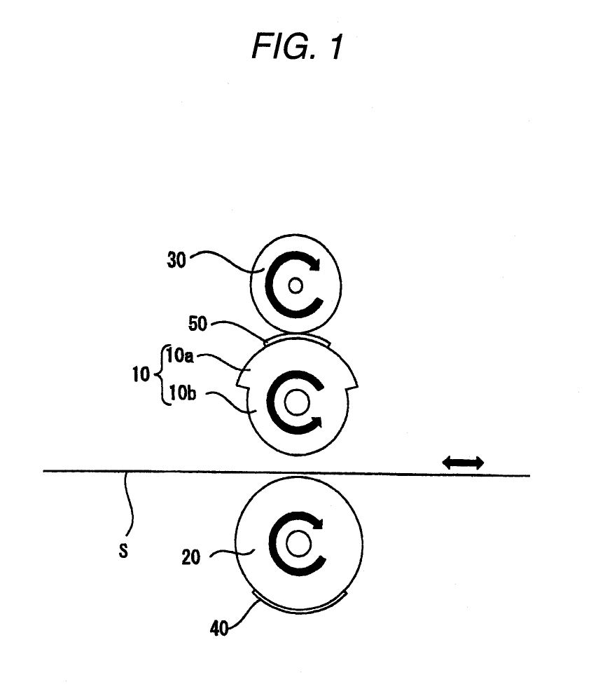

Firstly, the case of printing solid images and halftone dots on the print object S will be described. As shown in FIG. 1, the relief plate 50 is mounted on the plate mounting member 10a of the plate cylinder 10, and the cushioning sheet 40 is attached to the impression cylinder 20 corresponding to the mounting position of the relief plate 50 in advance of the printing. More specifically, the cushioning sheet 40 is attached to the impression cylinder 20 in such a fashion that the cushioning sheet 40 is overlapped with the relief plate 50 on the plate cylinder 10 when the plate cylinder 10 and the impression cylinder 20 are rotated. In this case, the cushioning sheet 40 is attached to the outer periphery of the impression cylinder 20 after being cut into the size that is larger than the relief plate 50 so that the cushioning sheet 40 overlaps (is brought into pressure-contact) with a whole surface of the relief plate 50. The biasing force to the impression cylinder 20 is so adjusted as to generate a predetermined pressure in a state where the impression cylinder 20 (cushioning sheet 40) and the plate cylinder 10 (relief plate 50) are brought into pressure-contact with each other.

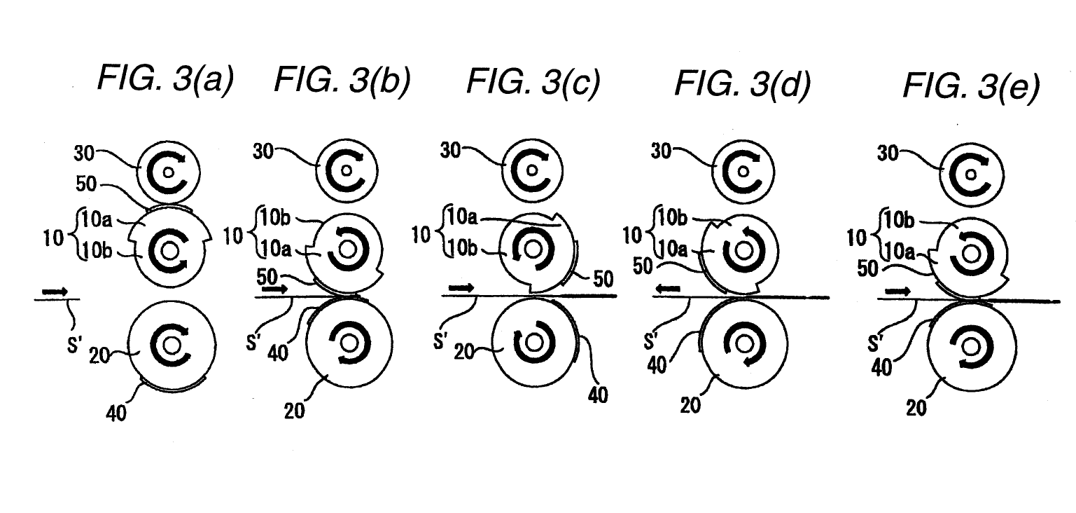

In this state, the impression cylinder 20 and the plate cylinder 10 are continuously rotated about the shaft centers, and the print object S is fed between the impression cylinder 20 and the plate cylinder 10 by the feeding device as shown in FIG. 3(a). After that, the print object S is sandwiched between the relief plate 50 on the plate cylinder 10 and the cushioning sheet 40 on the impression cylinder 20 as shown in FIG. 3(b), and the cushioning sheet 40 attached to the impression cylinder 20 is elastically deformed due to the pressure-contact with the relief plate 50. Owing to the elastic deformation, an impact caused by the pressure-contact is absorbed, thereby diminishing damage to be caused on the relief plate 50. Also, owing to the restoring force due to the elastic deformation of the cushioning sheet 40, the pressure is uniformly applied to the relief plate 50 (print object S) to bring the relief plate 50 into uniform pressure-contact with the print object S, thereby making it possible to uniformly transfer the ink applied on the relief plate 50 by the ink roller 30 onto the print object S.

By the rotation of the plate cylinder 10 and the impression cylinder 20 and the feeding of the print object S, printing of the pattern corresponding to the relief plate 50 mounted on the pate cylinder 10 is performed. The plate cylinder 10 and the impression cylinder 20 continuously rotate without changing the rotation direction, and the feeding of the print object S to the same direction (to the downstream) is continued in a state where the print object S is released from the state of being sandwiched between the relief plate 50 and the cushioning sheet 40, i.e. in a state where the cushioning sheet 40 is separated from the relief plate 50. In this case, since the cushioning sheet 40 is released from the pressure-contact with the plate cylinder 10 (relief plate 50), the cushioning sheet 40 is restored to the original state from the elastic deformation state. The feeding device changes the feeding direction of the print object S to the other direction (to the upstream) after feeding the print object S in the same direction (to the downstream) for a predetermined amount and positions the printing region (printing pattern) to a position directly below the contact position of the plate cylinder 10 and the impression cylinder 20 so that the print object S is sandwiched again between the continuously rotating plate cylinder 10 and the impression cylinder 20. That is, the print object S is fed to the reverse direction so that the printing is started from the position that is away from the printing region by a predetermined amount in the state where the plate cylinder 10 (relief plate 50) and the impression cylinder 20 (cushioning sheet 40) sandwich again the print object S therebetween.

As shown in FIG. 3(e), before or when the print object S is sandwiched between the plate cylinder 10 (relief plate 50) and the impression cylinder 20 (cushioning sheet 40), the feeding direction of the print object S by the feeding device is switched to the original direction (to the downstream). Therefore, the print object S is brought into the state where the print object S is sandwiched between the relief plate 50 on the plate cylinder 10 and the cushioning sheet 40 of the impression cylinder 20 as being fed to the original direction, so that the next printing is performed as described above.

By rotationally driving the plate cylinder 10 and the impression cylinder 20 continuously and changing the feeding direction of the print object S as described above, it is possible to print the patterns (solid images and halftone dots) of the relief plate 50 continuously with the predetermined gap being defined between the adjacent patterns.

Hereinafter, the case of printing linear images such as characters will be described. In this case, the cushioning sheet 40 attached to the impression cylinder 20 is detached from the impression cylinder 20 in advance of the printing, and the biasing force to the impression cylinder 20 is so adjusted that a predetermined pressure (pressure appropriate for printing linear images) is generated in a state where the rigid outer periphery of the impression cylinder and the plate cylinder 10 (relief plate 50) are brought into pressure-contact with each other.

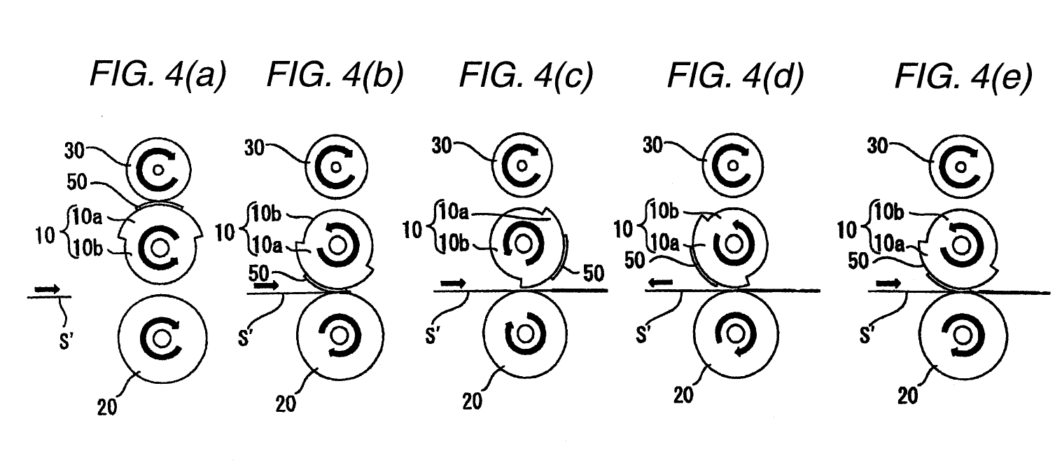

In this state, the impression cylinder 20 and the plate cylinder 10 are continuously rotated about the shaft centers, and the print object S is fed between the impression cylinder 20 and the plate cylinder 10 by the feeding device as shown in FIG. 4(a). After that, the print object S is sandwiched between the relief plate 50 on the plate cylinder 10 and the outer periphery of the impression cylinder 20 as shown in FIG. 4(b), and the ink applied on the relief plate 50 by the ink roller 30 is uniformly transferred onto the print object S.

By the rotation of the plate cylinder 10 and the impression cylinder 20 and the feeding of the print object S, printing of the pattern corresponding to the relief plate 50 mounted on the pate cylinder 10 is performed. The plate cylinder 10 and the impression cylinder 20 continuously rotate without changing the rotation direction, and the feeding of the print object S to the same direction (to the downstream) is continued in a state where the print object S is released from the state of being sandwiched between the relief plate 50 and the impression cylinder 20, i.e. in a state where the relief plate 50 and the impression cylinder 20 are separated from each other as shown in FIG. 4(c). As shown in FIG. 4(d), the feeding device changes the feeding direction of the print object S to the other direction (to the upstream) after feeding the print object S in the same direction (to the downstream) for a predetermined amount and positions the printing region (printing pattern) to a position directly below the contact position of the plate cylinder 10 and the impression cylinder 20 so that the print object S is sandwiched again between the continuously rotating plate cylinder 10 and the impression cylinder 20. That is, the print object S is fed to the reverse direction so that the printing is started from the position that is away from the printing region by a predetermined amount in the state where the plate cylinder 10 (relief plate 50) and the impression cylinder 20 sandwich again the print object S therebetween.

As shown in FIG. 4(e), before or when the print object S is sandwiched between the plate cylinder 10 (relief plate 50) and the impression cylinder 20, the feeding direction of the print object S by the feeding device is switched to the original direction (to the downstream). Therefore, the print object S is brought into the state of being sandwiched between the relief plate 50 on the plate cylinder 10 and the impression cylinder 20 as being fed to the original direction, so that the next printing is performed as described above.

By rotationally driving the plate cylinder 10 and the impression cylinder 20 continuously and changing the feeding direction of the print object S as described above, it is possible to print the patterns (linear images) of the relief plate 50 continuously with the predetermined gap being defined between the adjacent patterns as in the case of the solid images and the like.

According to the printing apparatus of this embodiment described above, since the cushioning sheet 40 is attachable to the outer periphery of the impression cylinder 20 and elastically deformed in the state where the cushioning sheet 40 is in pressure-contact with the relief plate 50 on the plate cylinder 10 via the print sheet S, the attachment of the cushioning sheet 40 to the impression cylinder 20 makes it possible to perform high quality printing while preventing the relief plate 50 from being damaged in the case of printing the solid images and the like (in the case where the pressure-contact force applied to the plate cylinder 10 is high).

Also, since the cushioning sheet restores in the state where the cushioning sheet 40 is separated from the relief plate 50 of the plate cylinder 10, it is possible to perform high quality printing while preventing the relief plate 50 from being damaged in the case of employing the intermittent rotary mode of intermittently bringing the relief plate 50 and the impression cylinder 20 into pressure-contact with each other.

Further, since the cushioning sheet 40 is detachable from the impression cylinder 20, when the cushioning sheet 40 is detached from the impression cylinder 20, it is possible to bring the rigid outer periphery of the impression cylinder 20 and the relief plate into pressure-contact with each other via the print object S, thereby realizing the state appropriate for printing the linear images.

Therefore, the printing apparatus according to this embodiment is capable of switching between the state appropriate for printing linear images and the state appropriate for printing solid images and halftone dots only by attaching and detaching the cushioning sheet 40 to and from the impression cylinder 20. Also, in the case where the cushioning sheet is worn due to printing, it is possible to readily replace the cushioning sheet with a new one without replacing the impression cylinder.

Further, since the cushioning sheet 40 has the cushioning layer 40a detachably and directly attached to the impression cylinder 20 and the surface layer 40b laminated directly on the cushioning layer 40 and brought into contact with the relief plate 50 on the plate cylinder 10 via the print object S, and since the cushioning layer 40a is made from the elastic resin while the surface layer is made from the resin film that is deformable and less elastic than the cushioning layer, the pattern on the relief plate hardly remains as a trance when the cushioning sheet 40 is brought into pressure-contact with the relief plate, thereby making it possible to maintain the function of uniformly applying the restoring force of the cushioning layer 40a to the relief plate via the print object S for a long time. Also, the less elastic surface layer prevents wearing, thereby making it possible to suppress depletion of the cushioning sheet 40.

Particularly, since the cushioning layer 40a is made from the urethane-based resin, and since the surface layer 40b is made from the polyethylene telephthalate film, the cushioning layer 40a (cushioning sheet 40) is capable of elastic deformation and has a high restoring force, and the surface layer 40b is deformable and less elastic (more rigid) than the cushioning layer 40a.

Further, since the cushioning layer 40a is weakly viscous, it is possible to attach the cushioning layer 40a (cushioning sheet 40) directly to the impression cylinder 20 without further providing a pressure sensitive adhesive layer or a viscous layer, and it is possible to smoothly detach the cushioning layer 40a from the impression cylinder 20.

Since the storage elastic modulus of the cushioning layer 40a of the cushioning sheet 40 is set to 2.00×10⁴ to 2.00×10⁵ (Pa), and since the storage elastic modulus of the surface layer 40b is set to 9.00×10⁷ to 4.00×10⁹ (Pa), it is possible to reliably absorb the impact on the relief plate 50 as well as to perform high quality printing by uniformly applying a pressure to the relief plate without fail.

### EXAMPLE 1

The inventor of this invention prepared various types of cushioning sheets that are different in thickness of cushioning layer 40a, storage elastic modulus of the cushioning layer 40a, amount of crosslinking agent for forming the cushioning sheet, thickness of the surface layer 40b, and the like to conduct a performance test of the cushioning sheets 40. In the test, a plate cylinder having an outer diameter of φ136 mm was used, a plate cylinder rotation number was set to 180 rpm, and a feeding speed of the print object was set to about 7,000 mm/min for intermittent operation. A viscosity agent obtained by adding a predetermined amount of an isocyanate-based crosslinking agent to a urethane-based polymer was used as the cushioning layer 40a, and the cushioning sheets each obtained by laminating the surface layer 40b with a separator (so-called exfoliate paper) by applying the viscosity agent on the surface layer 40b in the same manner as in ordinary viscosity agent application processes were used as samples. The cushioning sheet 40 wherein the cushioning layer 40a has a larger thickness was obtained by laminating the surface layer 40b after applying a viscous layer on the separator in order to ensure the thickness.

Each of the cushioning sheets 40 was attached to the impression cylinder of the above-described printing apparatus, and, as shown in Table 1, printing results obtained by using identical settings in the printing apparatus (a pressure-contact of the impression cylinder to the plate cylinder, rotation number, and the like) for the cushioning sheets were such that the sample No. 2 (material of surface layer 40b: PET, thickness of surface layer 40b: 50 μm, storage elastic modulus of surface layer 40b: 3.50×10⁸ (Pa), amount of crosslinking agent: 3 parts, thickness of cushioning layer 40a: 150 μm, storage elastic modulus of cushioning layer 40a: 5.00×10⁴ (Pa)), the sample No. 5 (material of surface layer 40b: PET, thickness of surface layer 40b: 75 μm, storage elastic modulus of surface layer 40b: 3.50×10⁸ (Pa), amount of crosslinking agent: 3 parts, thickness of cushioning layer 40a: 150 μm, storage elastic modulus of cushioning layer 40a: 5.00×10⁴ (Pa)), the sample No. 6 (material of surface layer 40b: PET, thickness of surface layer 40b: 75 μm, storage elastic modulus of surface layer 40b: 3.50×10⁸ (Pa), amount of crosslinking agent: 10 parts, thickness of cushioning layer 40a: 150 μm, storage elastic modulus of cushioning layer 40a: 1.10×10⁵ (Pa)), the sample No. 7 (material of surface layer 40b: PET, thickness of surface layer 40b: 75 μm, storage elastic modulus of surface layer 40b: 3.50×10⁸ (Pa), amount of crosslinking agent: 3 parts, thickness of cushioning layer 40a: 300 μm, storage elastic modulus of cushioning layer 40a: 5.00×10⁴ (Pa)), and the sample No. 8 (material of surface layer 40b: PET, thickness of surface layer 40b: 125 μm, storage elastic modulus of surface layer 40b: 3.50×10⁸ (Pa), amount of crosslinking agent: 3 parts, thickness of cushioning layer 40a: 150 μm, storage elastic modulus of cushioning layer 40a: 5.00×10⁴ (Pa)) did not damage the relief plate and achieved considerably good printing results.

The sample No. 1 (material of surface layer 40b: PET, thickness of surface layer 40b: 25 μm, storage elastic modulus of surface layer 40b: 3.50×10⁸ (Pa), amount of crosslinking agent: 3 parts, thickness of cushioning layer 40a: 150 μm, storage elastic modulus of cushioning layer 40a: 5.00×10⁴ (Pa)), the sample No. 3 (material of surface layer 40b: PET, thickness of surface layer 40b: 75 μm, storage elastic modulus of surface layer 40b: 3.50×10⁸ (Pa), amount of crosslinking agent: 3 parts, thickness of cushioning layer 40a: 50 μm, storage elastic modulus of cushioning layer 40a: 5.00×10⁴ (Pa)), the sample No. 4 (material of surface layer 40b: PET, thickness of surface layer 40b: 75 μm, storage elastic modulus of surface layer 40b: 3.50×10⁸ (Pa), amount of crosslinking agent: 0 part, thickness of cushioning layer 40a: 150 μm, storage elastic modulus of cushioning layer 40a: 1.00×10⁴ (Pa)), the sample No. 9 (material of surface layer 40b: PET, thickness of surface layer 40b: 250 μm, storage elastic modulus of surface layer 40b: 3.50×10⁸ (Pa), amount of crosslinking agent: 3 parts, thickness of cushioning layer 40a: 150 μm, storage elastic modulus of cushioning layer 40a: 5.00×10⁴ (Pa)), and the sample No. 10 (material of surface layer 40b: PE, thickness of surface layer 40b: 70 μm, storage elastic modulus of surface layer 40b: 1.00×10⁸ (Pa), amount of crosslinking agent: 3 parts, thickness of cushioning layer 40a: 150 μm, storage elastic modulus of cushioning layer 40a: 5.00×10⁴ (Pa)) did not damage the relief plate and achieved results that were not problematic. As shown in Table 2, printing was performed without attaching any cushioning sheet 40 as Comparative Example, and printing results obtained by Comparative Example were not good. In the printing results shown in Tables 1 and 2, meanings of symbols are as follows: o is good, Δ is no problem, and x is no good.

TABLE 1

| | | | | | | Surface | |
|---|---|---|---|---|---|---|---|
| | | | | | | Layer | |
| | | Surface | Cross- | Cushioning | Storage | Storage | |
| Example | Surface | Layer | linking | Layer | Cushioning | Elastic | |
| Sample | Layer | Thickness | Agent | Thickness | Layer Elastic | Modulus | Printing |
| No. | Material | (μm) | Amount | (μm) | Modulus (Pa) | (Pa) | Results |
| 1 | PET | 25 | 3 | 150 | 5.00 × 10⁴ | 3.50 × 10⁸ | Δ |
| 2 | | 50 | 3 | 150 | 5.00 × 10⁴ | | ◯ |
| 3 | | 75 | 3 | 50 | 5.00 × 10⁴ | | Δ |
| 4 | | | 0 | 150 | 1.00 × 10⁴ | | Δ |
| 5 | | | 3 | | 5.00 × 10⁴ | | ◯ |
| 6 | | | 10 | | 1.10 × 10⁵ | | ◯ |
| 7 | | | 3 | 300 | 5.00 × 10⁴ | | ◯ |
| 8 | | 125 | 3 | 150 | 5.00 × 10⁴ | | ◯ |
| 9 | | 250 | 3 | 150 | 5.00 × 10⁴ | | Δ |
| 10 | PE | 70 | 3 | 150 | 5.00 × 10⁴ | 1.00 × 10⁸ | Δ |

TABLE 2

| | | | | | | | |
|---|---|---|---|---|---|---|---|
| | | | | | | Surface | |
| | | | | | | Layer | |
| Comp. | | Surface | Cross- | Cushioning | Storage | Storage | |
| Ex. | Surface | Layer | linking | Layer | Cushioning | Elastic | |
| Sample | Layer | Thickness | Agent | Thickness | Layer Elastic | Modulus | Printing |
| No. | Material | (μm) | Amount | (μm) | Modulus (Pa) | (Pa) | Results |

| | | |
|---|---|---|
| 1 | No Cushioning Sheet | X |

This invention is not limited to the above embodiment, and it is of course possible to add various modifications within the scope that does not depart from the gist of this invention.

Thought the cushioning sheet 40 is described as one of the component parts of the printing apparatus in the above embodiment, this invention is not limited thereto, and the cushioning sheet 40 may be an independent article that is used for any existing printing apparatuses. Therefore, in the case of using the cushioning sheet 40 as the independent article, it is preferable to attach an exfoliate sheet on the viscous surface (surface of a viscous layer or a pressure sensitive adhesive layer when either one of them is provided on the cushioning layer 40) that is attached to the impression cylinder 20.

Though the cushioning sheet 40 is described as the laminated body of the cushioning layer 40a and the surface layer 40b in the above embodiment, this invention is not limited thereto, and a viscous layer or a pressure sensitive adhesive layer may be provided in addition to the surface layer 40b and the cushioning layer 40a for attaching the surface layer 40b and the cushioning layer 40a, so that the cushioning sheet 40 may be a lamented body of a cushioning layer 40a that is non-viscous and capable of elastic deformation and the viscous layer or the pressure sensitive adhesive layer for attaching the cushioning layer 40a to the impression cylinder 20. That is, any cushioning sheet may be used insofar as the cushioning sheet 40 is attachable to and detachable from the outer periphery of the impression cylinder 20 and capable of elastic deformation in the state of being brought into pressure-contact with the relief plate 50 on the plate cylinder 10 via the print object S as well as of restoring in the state where the relief plate 50 on the plate cylinder 10 is separated from the cushioning sheet 40. Also, the constitution of directly attaching the cushioning layer 40 to the impression cylinder 20 is not limitative, and the viscous layer or the pressure sensitive adhesive layer may be laminated on the cushioning layer 40a as described above, so that the cushioning layer 40a (cushioning sheet 40) is attached indirectly to the impression cylinder 20 via the viscous layer or the pressure sensitive adhesive layer.

Further, it is preferable to impart re-attachable property and a re-detachable property to the viscous layer or the like for attaching the cushioning sheet 40 to the impression cylinder 20 in order to reuse of the cushioning sheet 40, though it is not particularly described.

Though the printing apparatus in the above embodiment is described as having the plate cylinder 10 having the plate mounting member 10a and the small diameter member 10b that are continuously formed around the shaft center, the plate cylinder 10 may have a column-like appearance like the impression cylinder 20. Also, the printing apparatus of intermittent rotary mode capable of switching the feeding directions of the print object in accordance with the printing timing is described in the above embodiment, this invention is not limited thereto, and the printing apparatus may of course be of a continuous rotary mode wherein a plate cylinder 10 and an impression cylinder 20 are continuously and rotationally driven with the print object S being fed in one direction. Note that the adoption of the above-described cushioning sheet 40 for the printing apparatus of intermittent rotary mode is considerably useful since the printing apparatus of intermittent rotary mode is subject to prominent wear of the impression cylinder 20 due to the switching of the feeding directions of the print object S.

Though the impression cylinder 20 in the above embodiment is the metal roll, this invention is not limited thereto, and an impression cylinder having an outer periphery made from a rigid plastic or the like may be used as the impression cylinder 20. That is, insofar as at least an outer periphery of an impression cylinder is appropriately rigid to be brought into pressure-contact with the relief plate 50 for printing linear images, such impression cylinder may be used as the impression cylinder 20.

Though the print object S is described as the laminated body of the labeling material and the exfoliate paper in the above embodiment, the print object S may of course be a single layer body of a paper or a resin film, for example.

Though the impression cylinder 20 is biased toward the plate cylinder so that the pressure-contact force (pressure) of the impression cylinder 20 to the plate cylinder 10 (relief plate 50) is adjusted by adjusting the biasing force in the above embodiment, the pressure-contact force applied to the relief plate 50 may be adjusted by biasing the plate cylinder 10 toward the impression cylinder 20 and adjusting the biasing force or by biasing both of the plate cylinder 10 and the impression cylinder 20 toward each other and adjusting the biasing forces.

What is claimed is:

1. A cushioning sheet for a printing apparatus which includes a plate cylinder having a relief plate mounted on at least a part of an outer periphery of the plate cylinder and being operable to be rotationally driven about a shaft center, and an impression cylinder having a rigid outer periphery and being operable to be rotationally driven about a shaft center parallel to the shaft center of the plate cylinder, the printing apparatus in which the impression cylinder is adapted to be brought into pressure contact with the relief plate via a sheet-like print object fed between the plate cylinder and the impression cylinder,
wherein the cushioning sheet is attachable to and detachable from the outer periphery of the impression cylinder;
wherein the cushioning sheet is elastically deformable when being brought into pressure contact with the relief plate on the plate cylinder via the print object; and
wherein the cushioning sheet is restorable when being separated from the relief plate on the plate cylinder.

2. The cushioning sheet as set forth in claim 1, comprising:
a cushioning layer being directly or indirectly attachable to and detachable from the outer periphery of the impression cylinder; and
a surface layer directly or indirectly laminated on the cushioning layer and operable to be brought into pressure contact with the relief plate on the plate cylinder via the print object,
wherein the cushioning layer is comprised of an resin material having a first elasticity; and
wherein the surface layer is comprised of a deformable resin film having a second elasticity which is lower than the first elasticity.

3. The cushioning sheet as set forth in claim 2,
wherein the cushioning layer is comprised of an urethane-based resin; and
wherein the surface layer is comprised of a polyethylenetelephthalate film.

4. The cushioning sheet as set forth in claim 2, wherein the cushioning layer has adhesion.

5. A printing apparatus, comprising:
a plate cylinder having a relief plate mounted on at least a part of an outer periphery of the plate cylinder and being operable to be rotationally driven about a shaft center;
an impression cylinder having a rigid outer periphery and being operable to be rotationally driven about a shaft center parallel to the shaft center of the plate cylinder; and
a cushioning sheet detachably attached to the outer periphery of the impression cylinder so as to correspond to the relief plate on the plate cylinder,
wherein the impression cylinder is adapted to be brought into pressure contact with the relief plate via a sheet-like print object fed between the plate cylinder and the impression cylinder;
wherein the cushioning sheet is elastically deformable when being brought into pressure contact with the relief plate on the plate cylinder via the print object; and
wherein the cushioning sheet is restorable when being separated from the relief plate on the plate cylinder.

6. A printing method, comprising:
attaching the cushioning sheet as set forth in claim 1 to the outer periphery of the impression cylinder so as to correspond to the relief plate on the plate cylinder;
driving the plate cylinder and the impression cylinder in synchronization with each other;
feeding the print object between the plate cylinder and the impression cylinder; and
printing on the print object.
